(19) United States
(12) Patent Application Publication
(10) Pub. No.: US 2022/0382230 A1
(43) Pub. Date: Dec. 1, 2022

(54) Control System for a Technical Installation with Visually Coded Trend Curve Diagram

(71) Applicant: Siemens Aktiengesellschaft, Muenchen (DE)

(72) Inventor: Benjamin LUTZ, Pfinztal (DE)

(21) Appl. No.: 17/775,995

(22) PCT Filed: Nov. 12, 2020
(86) PCT No.: PCT/EP2020/081960

§ 371 Date: May 11, 2022

(30) Foreign Application Priority Data
Nov. 14, 2019 (EP) 19209040.5

(51) Int. Cl. G05B 15/02

(52) U.S. Cl. CPC G05B 15/02

(57) ABSTRACT

A control system for a technical installation includes an operator station server and an operator station client, wherein the operator station server includes a visualization service for outputting image information to the operator station client, where the operator station server uses a first measured value associated with a first technical object of the technical installation and a second measured value associated with a second technical object of the technical installation to generate a scatter diagram with an operating point visualized in the scatter diagram, and where the operator station server transmits the scatter diagram with the operating point to the operator station client via the visualization service, where the control system provides the at least one operating point with a visual coding generated based on an alarm status and/or a quality status of the first measured value associated with the operating point and the second measured value.

### CROSS-REFERENCE TO RELATED APPLICATIONS

This is a U.S. national stage of application No. PCT/EP2020/081960 filed 12 Nov. 2020. Priority is claimed on European Application No. 19209040.5 filed 14 Nov. 2019, the content of which is incorporated herein by reference in its entirety.

### BACKGROUND OF THE INVENTION

1. Field of the Invention

The invention relates to a control system of a technical installation, which has at least one operator station server and one operator station client.

2. Description of the Related Art

One aim in the automation of process-engineering installations is to operate these installations at their optimum operating points. In order to check the respective operating points, what are known as XY trends or scatter diagrams have become established. In these XY trend diagrams, two (process-engineering) process measured values are visualized as a 2-tuple with the same time base, together with a template characteristic. The two process measured values may be the pressure and the temperature of a turbine, for example. Moreover, the historical course of the 2-tuple can also be represented, in order to be able to track a trend of the 2-tuple operating point.

In FIG. 1, an exemplary scatter diagram 1 is represented with a pressure p along a Y-axis and with a flow rate q along an X-axis for checking an optimum operating point A1, A2, A3 of the 2-tuple pressure/flow rate of a mixer with a template characteristic 2 in accordance with the prior art. The arrows P1, P2 indicate a historical course of the operating points A1, A2, A3. As noticeable in FIG. 1, the scatter diagram 1 is non-contextual from a process-related point of view, i.e., only the values of the process values (p and q) are represented with the same time basis—important information relating to the validity and context is missing. However, these would be very helpful for an efficient optimization of the operating point A1, A2, A3 by an operator of the associated technical installation.

### SUMMARY OF THE INVENTION

It is an object of the invention to provide a control system for a technical installation, which simplifies an optimization of an operating point of the technical installation by an operator of the technical installation and makes it more efficient.

This and other objects and advantages are achieved in accordance with the invention by a control system of a technical installation, which has at least one operator station server and one operator station client, where the operator station server includes a visualization service for outputting image information to the operator station client. The operator station server is configured to generate a scatter diagram with at least one operating point visualized in the scatter diagram from a first measured value associated with a first technical object of the technical installation and a second measured value associated with a second technical object of the technical installation. The operator station server is additionally configured to transmit the scatter diagram with the operating point to the operator station client via the visualization service.

The inventive control system is characterized in that it is configured to provide the at least one operating point with a visual coding, which is generated based on an alarm status and/or a quality status of the first measured value and the second measured value associated with the at least one operating point.

The technical installation can be an installation from the process industry, such as a chemical, pharmaceutical or petrochemical installation, or an installation from the food and beverage industry. This also encompasses any installations from the production industry, factories, in which, for example, automobiles or goods of all kinds are produced. Technical installations that are suitable for performing the method in accordance with the invention can also come from the power generation sector. The term “technical installation” also encompasses wind turbines, solar installations or power generation plants.

These installations each have a control system or at least a computer-aided module for open-loop and closed-loop control of the running process or production. In the present context, a control system is understood to mean a computer-aided technical system, which comprises functionalities for representing, operating and controlling a technical system, such as a manufacturing or production installation. In addition to the operator station server and the operator station client provided in the present case, the control system can comprise sensors for determining measured values and various actuators. Additionally, the control system can have what are known as process-oriented components, which serve to activate the actuators or sensors. Furthermore, the control system can have inter alia means for engineering. The term control system is additionally intended to also encompass further computing units for more complex closed-loop controls and systems for data storage and data processing.

In the present context, an “operator station server” is understood to mean a server that centrally captures data of an operator control and monitoring system and generally also alarm and measured value archives of a control system of a technical installation, and makes this data available to users (known as operators). The operator station server generally establishes a communication connection to automation systems of the technical installation and forwards data of the technical installation to what is known as the operator station client, which data serves the purpose of operator control and monitoring of an operation of the individual functional elements of the technical installation.

The operator station server may have client functions for accessing the data (archives, messages, tags, variables) of other operator station servers. This means that images of an operation of the technical installation on the operator station server can be combined with variables of other operator station servers (server-server communication). The operator station server can be a SIMATIC PCS 7 industrial workstation server from SIEMENS, without being restricted to this.

An operator is understood to mean a human user of the technical installation. The operator interacts with the technical installation or the control system thereof via specific user interfaces and controls specific technical functions of the technical installation. To this end, the operator may use an operator control and monitoring system (the operator station client in conjunction with the operator station server) of the control system.

A technical object is understood to mean a self-contained technical unit, which can be integrated into a higher-level control level. One such technical object may, for example, be an amalgamation of a plurality of measuring points or a larger installation part of an industrial installation. The technical object does not have to originate from the field of industrial installations, however, but rather may also be a motor module of an automotive, a ship or the like, for example.

In accordance with the invention, the control system is configured to provide the at least one operating point with a visual coding, which is generated based on an alarm status and/or a quality status of the first measured value and the second measured value associated with the at least one operating point. On account of the immediate representation of an alarm status and/or a quality status, an operator obtains a direct statement relating to a classification of an optimization of an operating point in the context of operating the technical installation. The efficiency involved in the optimization of the operating point can be significantly increased via the control system in accordance with disclosed embodiments.

The visual coding can comprise a color coding and/or a shape coding in order to display the alarm status and/or the quality status particularly efficiently. For instance, a white color of an operating point shown in the diagram can signal an alarm status “no alarm”, a yellow color an alarm status “moderate alarm” and a red color an alarm status “main alarm”. For a quality status “good”, the operating point can have for instance a square shape, for a quality status “medium” a “triangle shape” and for a quality status “poor” a diamond shape. As a result, the operator can detect the coding and the underlying status considerably more easily and quickly and can react accordingly.

In the context of a preferred embodiment of the invention, the scatter diagram can be switched into a continuous time diagram, where the control system is configured to represent the first measured value, the second measured value and at least one operating point associated with the two measured values in a time continuous manner in the continuous time diagram, and where the control system is further configured to provide the at least one operating point in the continuous time diagram with a visual coding, which is generated based on an alarm status and/or a quality status of the first measured value and the second measured value associated with the at least one operating point.

On account of the possibility of switching from the scatter diagram into a continuous time diagram, it is possible to more quickly determine a cause of a specific alarm status and/or quality status. Reference should be made here to the description of the exemplary embodiments (in particular FIG. 3), where the advantage of this characteristic value is clearly visible.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The above-described properties, features and advantages of this invention and the manner in which these are achieved will now be made more clearly and distinctly intelligible in conjunction with the following description of the exemplary embodiment, which will be described in detail making reference to the drawing, in which:

FIG. 1 shows a scatter diagram in accordance with the prior art;

FIG. 2 shows a scatter diagram of a control system in accordance with the invention;

FIG. 3 shows a continuous time diagram of a control system in accordance with the invention; and

FIG. 4 shows a schematic block diagram of part of a control system in accordance with the invention.

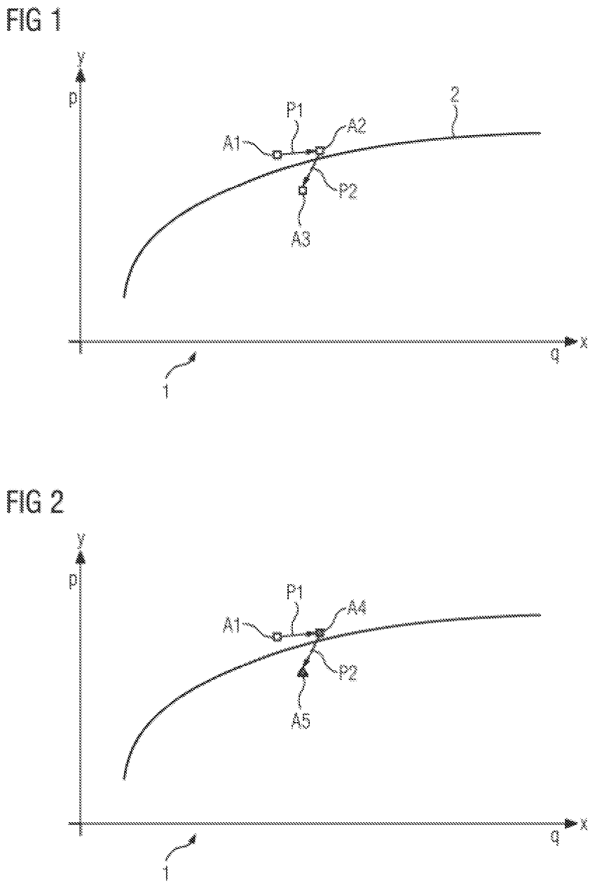

FIG. 2 substantially shows the same scatter diagram 1 as FIG. 1. Contrary to the per se known scatter diagram 1 according to FIG. 1, however, two operating points A4, A5 are shown in the scatter diagram 1, each of which has a visual coding, which is produced based on an alarm status and/or a quality status of a first measured value and a second measured value associated with the at least one operating point. The operating point A4 in FIG. 2 has a specific color (here symbolized by a hatching), which differs from the color of the alarm-free operating point A1 and indicates the presence of an alarm of (process) measured values underlying the operating point A4. The second operating point A5 has, in addition to the color that differs from the operating point A1 (likewise symbolized by a hatching) a shape that differs from the other two operating points A1, A4 (the operating point A5 has a triangular shape contrary to the rectangular shapes of the operating points A1, A4). This difference indicates that a specific quality of the (process) measured values underlying the operating point exists.

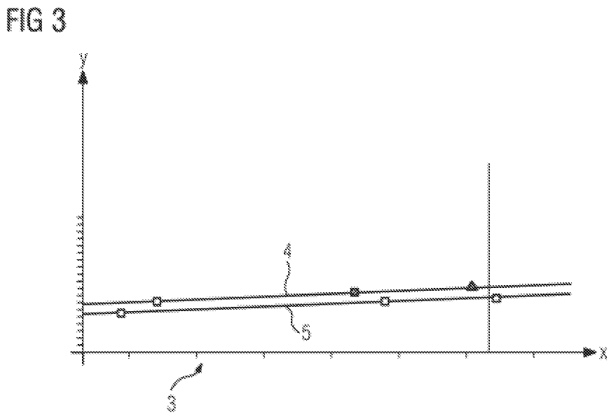

In the scatter diagram 1, an operating point A1, A2, A3, A4, A5 is assigned in each case to a measured value pair. As a result, the operating point A1, A2, A3, A4, A5 are aggregated values. The information relating to the actual source of the quality status or the alarm status (measured value p or measured value q) is not to be inferred from the view of the scatter diagram 1 (cf. FIG. 2). The control system can therefore have a dynamic switchover function between the scatter diagram 1 and a continuous time diagram 3, where the latter is shown in FIG. 3.

The curve 4 that extends upward in the drawing plane in FIG. 3 corresponds to a continuous time representation of the (process) measured value p from FIG. 2. The curve 5 which runs downward in the drawing plane in FIG. 3 corresponds to a continuous time representation of the (process) measured value p from FIG. 2.

As visible from FIG. 3, the (process) measured value p is responsible for the poor quality code (symbolized by a triangular shape) of the newest operating point A5 from FIG. 2. Moreover, it is immediately noticeable that the cause of the changed alarm status (different color identified by hatching) is to be sought in the (process) measured value p.

In the continuous time representation (FIG. 3), it is possible to select a defined historical region, for which the historical operating points A1, A2, A3, A4, A5 are to be checked.

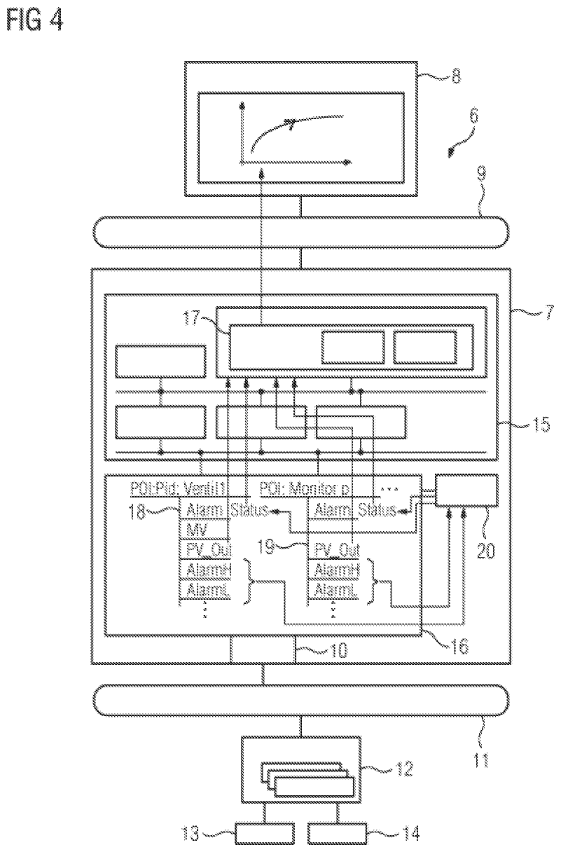

FIG. 4 shows a part of a control system 6 of a process installation in accordance with the invention. The control system 6 comprises a server of an operating system or an operator station server 7 and an associated operator station client 8. The operator station server 7 and the operator station client 8 are connected to one another via a terminal bus 9 and to further components of the control system 7 (not shown) such as an engineering system server or a process data archive.

A user or operator has access to the operator station server 7 via the operator station client 8 over the terminal bus 9, in the context of operator control and monitoring. The terminal bus 9 can be configured, without being limited thereto, as an industrial Ethernet, for instance.

The operator station server 7 has a device interface 10, which is connected to an installation bus 11. This can be used by the operator system server 7 to communicate with an automation device 12 of the control system 6. The installation bus 11 can be configured, without being limited thereto, as an industrial Ethernet, for instance. The automation device 12 is in turn connected to at least one first technical object 13 and to a second technical object 14. In addition, the automation device 12 may be connected to any number of further subsystems (not shown).

Integrated in the operator station server 7 is a visualization service 15, via which a transmission of (visualization) data to the operator station client 8 can occur. Additionally, the operator station server 7 has a process image 16 of the process installation.

A trend service 17, which is part of the visualization service 15, calculates an aggregation of a quality status and an alarm status for the individual operating points A1, A2, A3, A4, A5 (cf. FIG. 2 and FIG. 3) shown in the scatter diagram 1. Here, the trend service 17 accesses process objects 18, 19 stored in the process image 16. These are in turn assigned to the first technical object 13 or the second technical object 14 and contain inter alia the (process) measured values originating from the two technical objects 13, 14. An alarm status, which each of the two process objects 18, 19 (or the associated process measured values) have relating to a current point in time, calculates a separate alarm service 20 and stores this information for further use by the trend service 17 in the process image 16. The quality status for the aggregation in the operating points A1, A2, A3, A4, A5 can be taken directly from associated values of the respective process measured values.

The quality of a measured value can be influenced on different levels:
in the field, if a wire break is identified, for instance,
in the automation device 13, if the connection to the field is interrupted,
in the operator station server 7, if the connection to the automation device 13 is interrupted.

The quality stages of a measured value are generally standardized and are awarded by the different components in the control system 6. The operator cannot influence the quality status, and only receives the quality status shown. The quality status can be expressed in the stages “good” (everything ok), “uncertain” (no value update received for a “longer” time) and “bad” (no update received for a long time/wire break established/connection failure established).

The trend service 17 furthermore makes available the previously described switchover functionality between the scatter diagram 1 and the continuous time diagram 3.

Although the invention has been illustrated and described in greater detail with the preferred exemplary embodiment and the figures, the invention is not restricted by the examples disclosed and other variations can be derived therefrom by the person skilled in the art without departing from the protective scope of the invention.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-3. (canceled)

4. A control system of a technical installation, comprising:
one operator station client;
at least one operator station server having a visualization service for outputting image information to the one operator station client;
wherein the operator station server is configured to generate a scatter diagram with at least one operating point visualized in the scatter diagram from a first measured value associated with a first technical object of the technical installation and a second measured value associated with a second technical object of the technical installation;
wherein the operator station server is configured to transmit the scatter diagram with the at least one operating point via the visualization service to the operator station client; and
wherein the control system is configured to provide the at least one operating point with a visual coding, which is generated based on an alarm status and a quality status of the first measured value and the second measured value associated with the at least one operating point.

5. The control system as claimed in claim 1, wherein the visual coding comprises at least one of a color coding a shape coding.

6. The control system as claimed in claim 4, wherein the scatter diagram is switchable into a continuous time diagram;
wherein the control system is further configured to display the first measured value, the second measured value and at least one operating point associated with the two measured values in a time-continuous manner in the continuous time diagram; and
wherein the control system is further configured to provide the least one operating point in the continuous time diagram with a visual coding, which is generated based on at least one of an alarm status and a quality status of the first measured value and the second measured value associated with the at least one operating point.

7. The control system as claimed in claim 5, wherein the scatter diagram is switchable into a continuous time diagram;
wherein the control system is further configured to display the first measured value, the second measured value and at least one operating point associated with the two measured values in a time-continuous manner in the continuous time diagram; and
wherein the control system is further configured to provide the least one operating point in the continuous time diagram with a visual coding, which is generated based on at least one of an alarm status and a quality status of the first measured value and the second measured value associated with the at least one operating point.
